(19) United States
(12) Patent Application Publication
(10) Pub. No.: US 2014/0299196 A1
(43) Pub. Date: Oct. 9, 2014

(54) Water Lifting System and Method Having Such a System

(71) Applicant: KSB Aktiengesellschaft, Frankenthal (DE)

(72) Inventors: Thomas Heng, Worms (DE); Benedikt Freienstein, Grimma (DE)

(21) Appl. No.: 14/364,347

(22) PCT Filed: Nov. 22, 2012
(86) PCT No.: PCT/EP2012/073301

§ 371 Date: Jun. 11, 2014

(30) Foreign Application Priority Data
Dec. 12, 2011 (DE) 10 2011 088 246.4

(51) Int. Cl. A62C 29/00; A62C 31/28; A62C 3/10; F04D 1/06; F04D 13/06

(52) U.S. Cl. CPC A62C 29/00; F04D 1/06; F04D 13/06; A62C 3/10; A62C 31/28
USPC 137/1; 137/565.37; 137/565.31

(57) ABSTRACT

A water lifting system, in particular a fire extinguishing system for offshore installations, such as oil and/or gas production platforms or ships or the like, and a method for operating a water lifting system, is provided. The system includes a pump, a pump-turbine assembly having a pump unit and a turbine unit, and a line connecting the pump-turbine assembly's pump unit output opening and the pump suction opening through which a volume flow (Q_{S}) is conducted. The volume flow (Q_{S}) include a first partial volume flow (Q_{F}) and a second partial volume flow (Q_{T}). The first partial volume flow (Q_{F}) is conducted to at least one water extraction point and the second partial volume flow (Q_{T}) is conducted to the input opening of the pump-turbine assembly's turbine unit.

### CROSS REFERENCE TO RELATED APPLICATIONS

This application is a National Phase of PCT International Application No. PCT/EP2012/073301, filed Nov. 22, 2012, which claims priority under 35 U.S.C. §119 from German Patent Application No. 10 2011 088 246.4, filed Dec. 12, 2011, the entire disclosures of which are herein expressly incorporated by reference.

### BACKGROUND AND SUMMARY OF THE INVENTION

The invention relates to a water lifting system, especially a fire extinguishing plant for offshore installations, such as oil and/or gas production platforms, or ships, or the like, with a pump having a suction port and a discharge port, a pump-turbine assembly having a pump unit and a turbine unit, wherein pump unit and turbine unit have in each case a suction or inlet port and a discharge port, and with a line connecting the discharge port of the pump unit of the pump-turbine assembly and the suction port of the pump, and conducting a volume flow, and also relates a method using such a system.

A device for the starting of pumps for fire extinguishing purposes and similar purposes, in which it is necessary to overcome large suction heads, is known from German patent publication no. DE 643 151 A. Since the pump used for fire extinguishing purposes cannot draw up the required water alone in the case of large suction heads, the pump is connected via a line to an auxiliary pump which is arranged in an extinguishant reservoir or the like and is driven by means of a liquid or air turbine, the propellant of which is delivered by a special propellant pump. The turbine is connected to the propellant pump via two lines. In this case, it is disadvantageous that provisions have to be made, which provisions can compensate again the possible leakage losses in the propellant circuit. Since the propellant is pumped in a closed circuit from the propellant pump to the turbine and back again, the propellant is continuously heated up more and has to be cooled since otherwise parts of the plant can suffer damage.

The object of the invention is to create a reliable water lifting system, which economizes in installation space, is to be installed at lower cost and at the same time is afflicted with lower losses, and to create a method for operating such a water lifting system.

The object is achieved by the volume flow comprising a first partial volume flow and a second partial volume flow, wherein a line conducting the first partial volume flow is connected to at least one water extraction point and a line conducting the second partial volume flow is connected to an inlet port of the turbine unit of the pump-turbine assembly.

Consequently, the pump-turbine assembly needs to be connected to only two lines, which lead from the platform or from the ship into the sea. Moreover, a hydraulic circuit, which is operated by a fluid, especially hydraulic oil, for driving the pump-turbine assembly, a tank filled with the fluid, and a cooling device with heat exchangers or the like for cooling the fluid, can be dispensed with.

According to one embodiment, the turbine unit has a discharge port which is connected to a water reservoir or leads to the water reservoir.

In order to increase the operational reliability during starting of the water lifting system, provision is made on the offshore installation or the ship for a water supply which is accommodated in a tank.

According to the invention, an outlet opening of the tank is connected to the suction port of the pump.

According to a further embodiment, the line conducting the volume flow is connected to an inlet opening of the tank.

Also, the line conducting the volume flow can be connected to the outlet opening of the tank.

The discharge port of the pump is expediently connected to the at least one water extraction point via the line conducting the first partial volume flow.

According to a further embodiment, it is provided that the discharge port of the pump is connected to the inlet port of the turbine unit of the pump-turbine assembly via the line conducting the second partial volume flow.

In an alternative embodiment, the discharge port of the pump unit is connected to a suction port of an additional pump device, preferably a high-pressure pump.

A further advantageous embodiment ensues if the discharge port of the additional pump is connected to the inlet port of the turbine unit of the pump-turbine assembly via the line conducting the second partial volume flow.

In order to protect the pump-turbine assembly, which permanently resides in the salty seawater, against seizures and blockages, an electric motor is expediently attached to the pump-turbine assembly.

The object of the invention is also achieved by a first partial volume flow of a volume flow, which is extracted from a water reservoir and delivered via a line, being delivered to at least one water extraction point by means of a line conducting the first partial volume flow, and by a second partial volume flow being delivered back to the water reservoir by means of a line conducting the second partial volume flow.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows the schematic representation of an offshore platform having a water lifting device according to an embodiment of the invention with a pump and a pump-turbine assembly,

FIG. 2 shows an offshore platform having a water lifting device according to FIG. 1 with a closed pressurized tank for a water supply,

FIG. 3 shows an offshore platform and water lifting device according to FIG. 1 with an open tank for a water supply,

FIG. 4 shows an offshore platform with a further embodiment of the water lifting device according to FIG. 3,

FIG. 5 shows an offshore platform with a further embodiment of the water lifting device according to FIG. 3,

FIG. 6 shows an offshore platform according to FIG. 1 having a water lifting device with a pump, a pump-turbine assembly and an additional pump device,

FIG. 7 shows an offshore platform and water lifting device with a pump unit and a pump-turbine assembly according to an embodiment of the invention,

FIG. 8 shows an offshore platform and water lifting device according to FIG. 1 with a motor arranged on the pump-turbine assembly 6.

### DETAILED DESCRIPTION

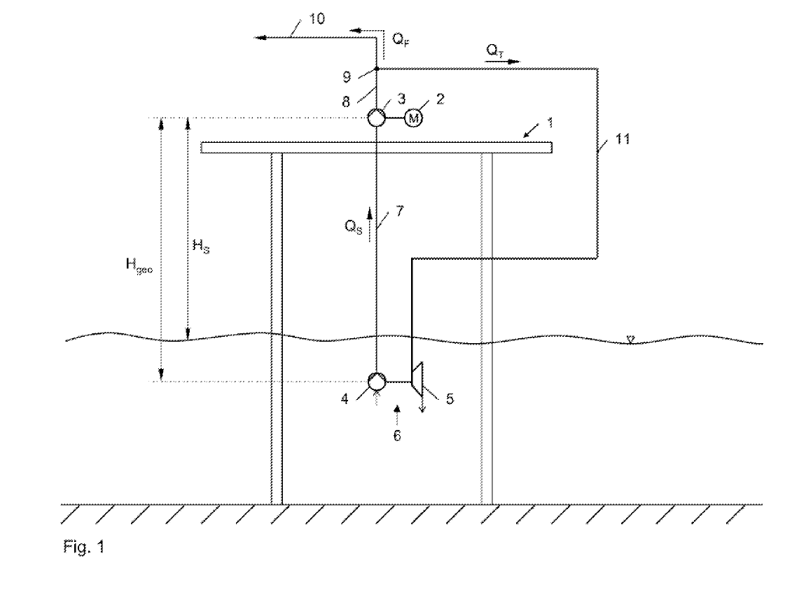

FIG. 1 schematically shows an offshore installation 1 in the embodiment of an oil and/or gas platform with a pump 3, preferably a circulating pump, which is arranged on the offshore installation 1 and driven via a motor 2, and with a pump-turbine assembly 6, located in the sea, having a pump unit 4 and a turbine unit 5. Pump unit 4 and turbine unit 5 can be designed as separate units or as units which are accommodated in a housing. The pump unit 4 for example comprises a circulating pump which is designed as an underwater pump, and the turbine unit 5 comprises an underwater pump, driven as a turbine, preferably a multistage underwater pump or a multistage circulating pump. The two components are preferably arranged on a shaft and/or interconnected via a transmission.

The pump unit 4 has a suction port—not shown in more detail—which lies below the sea level, preferably in a region with little swell. A discharge port of the pump unit 4 is connected to a suction port of the pump 3 via a first line 7, preferably a pipe or a hose, which conducts a volume flow Q_{S}. A second line 8 leads from a discharge port of the pump 3 to an inlet opening of a first distribution device 9. A first outlet opening of the distribution device 9 is connected to at least one water extraction point, especially a fire extinguishing device, for example a sprinkler system, hydrant or the like—not shown in the drawings—which is arranged on the offshore installation 1, via a third line 10 conducting a first partial volume flow Q_{F}. A second outlet opening of the distribution device 9 is connected to an inlet port of the turbine unit 5 of the pump-turbine assembly 6 via a fourth line 11 conducting a second partial volume flow Q_{T}. Therefore, the volume flow Q_{S} comprises a first partial volume flow Q_{F} and a second partial volume flow Q_{T}, wherein a line 10 conducting the first partial volume flow Q_{F} is connected to at least one water extraction point and a line 11 conducting the second partial volume flow Q_{T} is connected to the inlet port of the turbine unit 5 of the pump-turbine assembly 6. The turbine unit 5 in turn has a discharge port which leads to a water reservoir, especially the sea, or is at least connected to the water reservoir, and which lies beneath the water level and via which the water which is delivered to the turbine unit 5 is ejected into the water reservoir.

The motor 2, which is preferably designed as an internal combustion engine or turbine, drives the pump 3 which is located on the platform. The pump-turbine assembly 6, which is located underwater, is driven via the second partial volume flow Q_{T} which is conducted through the line 11. The pump-turbine assembly 6 serves as a forwarding pump for the pump 3 and ensures lifting of the water level to the level of the pump 3.

Used as an extinguishing pump, the pump 3, in the case of a fire, has to provide the first partial volume flow Q_{F}, which is conducted via the line 10 and required for firefighting, the required pressure head H_{D} and also the second partial volume flow Q_{T}, which is conducted via the line 11 and drives the turbine. In this case, the second partial volume flow Q_{T} is significantly lower than the first partial volume flow Q_{F} for firefighting. The pump unit 4 has to produce the suction head H_{S} and also the two partial volume flows Q_{F} and Q_{T}.

The turbine unit 5 has to therefore produce a second partial volume flow Q_{T} and also the pressure head H_{D} plus the suction head H_{S}. Especially suitable for this, as previously mentioned, is a multistage underwater pump, driven as a turbine, which can convert the high pressure into a rotational movement for driving the pump unit 4. As the pump unit 4, circulating pumps, designed as single-stage scroll casing pumps which overcome the suction head H_{S} with the high volume flow Q_{S} or the partial volume flows Q_{F} and Q_{T} which form the volume flow Q_{S}, for example for firefighting, are particularly well suited.

Therefore, a first partial volume flow Q_{F} of the volume flow Q_{S}, which is extracted from the water reservoir and delivered via the line 7, is thus delivered to at least one water extraction point by means of the line 10 conducting the first partial volume flow Q_{F} and the second partial volume flow Q_{T} is delivered back to the water reservoir by means of the line 11 conducting the second partial volume flow Q_{T}.

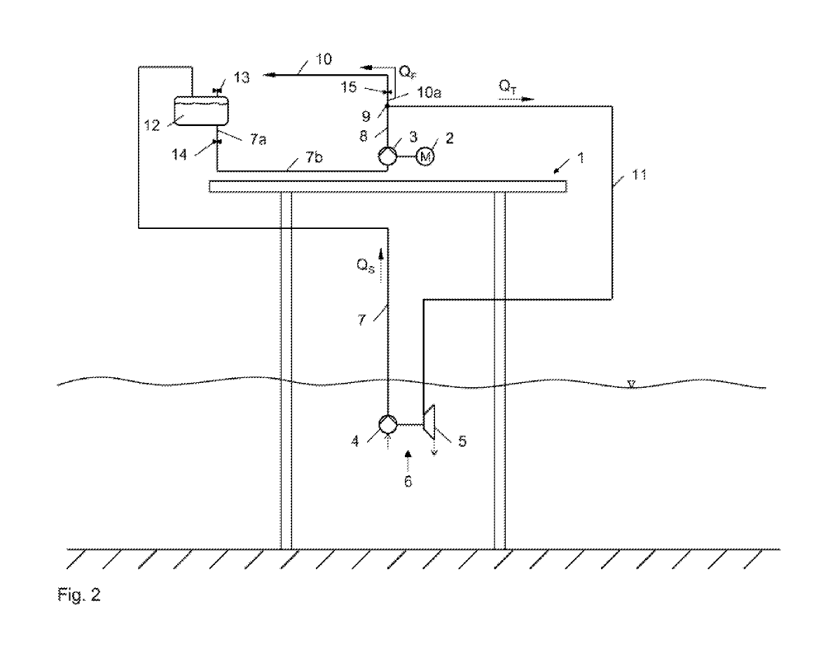

The embodiment shown in FIG. 2 largely corresponds to the exemplary embodiment shown in FIG. 1. In order to further increase the operational reliability of the system, provision is additionally made on the platform for a water supply, wherein the water supply is accommodated in a tank 12. The line 7 conducting the volume flow Q_{S} is connected to an inlet opening of the tank 12. The discharge port of the pump unit 4 of the pump-turbine assembly 6 is connected to the inlet opening on the upper side of the tank 12 directly via the line 7 conducting the volume flow Q_{S}, wherein the tank 12 in the case of the exemplary embodiment shown in FIG. 2 is designed as a closed pressurized tank. If required, a vent valve 13 can be arranged on the upper side of the tank 12 or, alternatively, on one of the walls in a region which lies above the water level. An outlet opening of the tank 12 is connected to the suction port of the pump 3. For this, the outlet opening at the bottom of the tank 12 is connected via a fifth line 7a to an inlet of a first fitting 14, for example a valve or a gate, which can close off the line 7a. The outlet of the valve 14 is connected via a sixth line 7b to the suction port of the pump 3 which is driven by means of the motor 2. The discharge port of the pump 3 is connected to the at least one water extraction point via the line 10 conducting the first partial volume flow Q_{F} and is connected to the inlet port of the turbine unit 5 of the pump-turbine assembly 6 via the line 11 conducting the second partial volume flow Q_{T}. The line 8 leads from the discharge port of the pump 3 to the inlet opening of the distribution device 9. The first outlet opening of the distribution device 9 is connected to an inlet of a second valve 15 by means of a seventh line 10a conducting the first partial volume flow Q_{F}. Via the line 10 conducting the first partial volume flow Q_{F}, the outlet of the valve 15 is fluidically connected to the at least one water extraction point, which is not shown. The second outlet opening of the distribution device 9 is connected to the inlet port of the turbine unit 5 of the pump-turbine assembly 6 via the line 11 conducting the second partial volume flow Q_{T}.

For starting the system, the valve 14 on the tank 12 is opened and the pump 3 is started. The vent valve 13 which is attached to the tank 12 lets air flow into the tank 12. Therefore, the water can flow out of the tank 12, via the lines 7a and 7b, into the pump 3. The valve 15 is initially closed during starting of the pump 3 so the water flows via the lines 8 and 11 and the turbine unit 5 into the sea and in the process drives the pump-turbine assembly 6. The pump unit 4 of the pump-turbine assembly 6 draws in seawater as a result and delivers it into the tank 12. If the tank 12 has reached the required filling level for restarting the system by means of feed through the turbine unit 5, the valve 15 is opened and the vent valve 13 is closed. At the water extraction point, or points, the maximum amount of water delivered by the pump unit 4 and the pump 3 is now available. The vent valve 13 has to be designed so that during starting of the pump 3 it prevents a vacuum in the tank 12 and in the case of a pressure increase during operation of the system closes off the tank 12 in a pressure-tight manner.

Alternatively, the vent valve 13 can be omitted. For this, it is to be ensured that the water level in the tank 12 does not lie above the level in the pump 3. Consequently, the water cannot flow out of the tank 12 through the pump 3 and the turbine unit 5 into the open air or the sea. Therefore, it is ensured that sufficient water is available for repeated starting of the system after a shutdown.

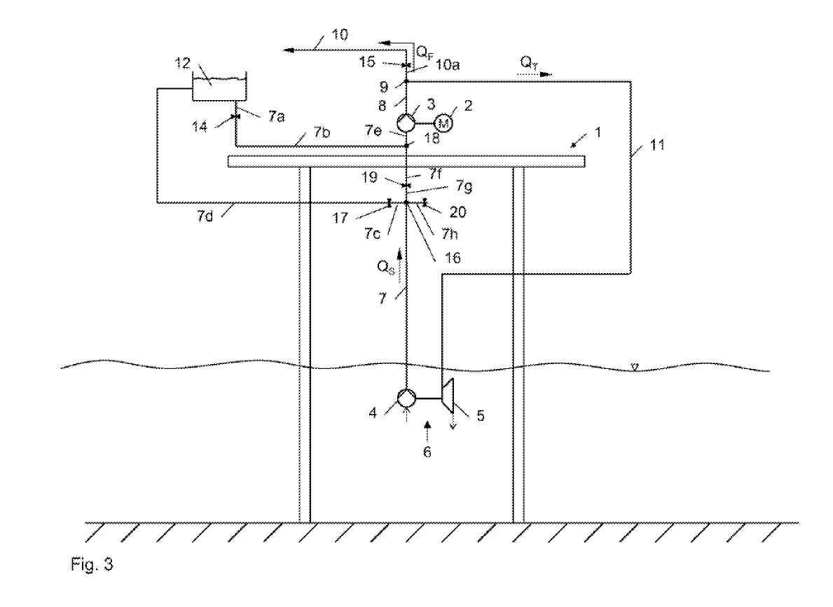

A further embodiment for starting the system is shown in FIG. 3. In addition to the distribution device 9, which connects the pump 3 via the lines 8 and 10 to the water extraction points and via the line 11 connects the pump 3 to the turbine unit 5 of the pump-turbine assembly 6, provision is made for a second distribution device 16, the inlet opening of which is connected to the discharge port of the pump unit 4 of the pump-turbine assembly 6 via the line 7 conducting the volume flow Q_{S}. Via an eighth line 7c, one of the outlet openings of the distribution device 16 is connected to an inlet of a third valve 17. An outlet of the valve 17 is fluidically connected by a ninth line 7d to the inlet opening of the tank 12. As a result, the line 7 conducting the volume flow Q_{S} is connected to the outlet opening of the tank 12. The inlet opening is provided on one of the walls of the tank 12 in a region which is located beneath the water level. In the case of the tank 12 shown here, it is a tank which on its upper side is fully or partially open, or a tank with an opening which connects the interior of the tank 12 to the outside environment. The outlet opening at the bottom of the tank 12 is connected via the line 7a to the inlet of the valve 14. The outlet of the valve 14 is connected via the line 7b to a first inlet opening of a third distribution device 18. An outlet opening of the distribution device 18 is fluidically connected via a tenth line 7e to the suction port of the pump 3. A second inlet opening of the distribution device 18 is connected by means of an eleventh line 7f to an outlet opening of a fourth valve 19, the inlet opening of which is connected in turn via a twelfth line 7g to an outlet opening of the distribution device 16. Therefore, the distribution device 16 is connected to the distribution device 18 via a system of lines which comprises the lines 7a, 7b, 7c and 7d, and via a system of lines which comprises 7f and 7g. On a further outlet of the distribution device 16 provision is made for a vent line 7h which is connected to a vent valve 20. The connecting of the discharge port of the pump 3 is carried out in the same way, as described in FIG. 2.

For starting the system with the open tank 12, first of all the valves 15, 17, 19 have to be closed and valve 14 and vent valve 20 opened. The closed valve 17 prevents an escape of water from the tank 12, which is contingent upon level differences of the tank 12 and the pump unit 4. Via the lines 7a, 7b and 7e, the water flows into the pump 3 and from there flows into the sea via the lines 8 and 11 and also via the pump unit 5. The pump unit 4 of the pump-turbine assembly 6 delivers water into the line 7 until the air which is present in this can escape from the vent valve 20. As soon as water reaches the vent valve 20, the vent valve 20 is closed and the valve 17 opened. The water which is delivered by the pump unit 4 is delivered into the tank 12 via the lines 7, 7c and 7d. If the tank 12 has reached the defined filling level for restarting the system, the valves 14 and 17 are closed and the valves 15 and 19 opened. The valve 14 prevents the escape of water from the tank 12 and the valve 19 enables the feed of the pump 3 by means of the pump unit 4 of the pump-turbine assembly 6.

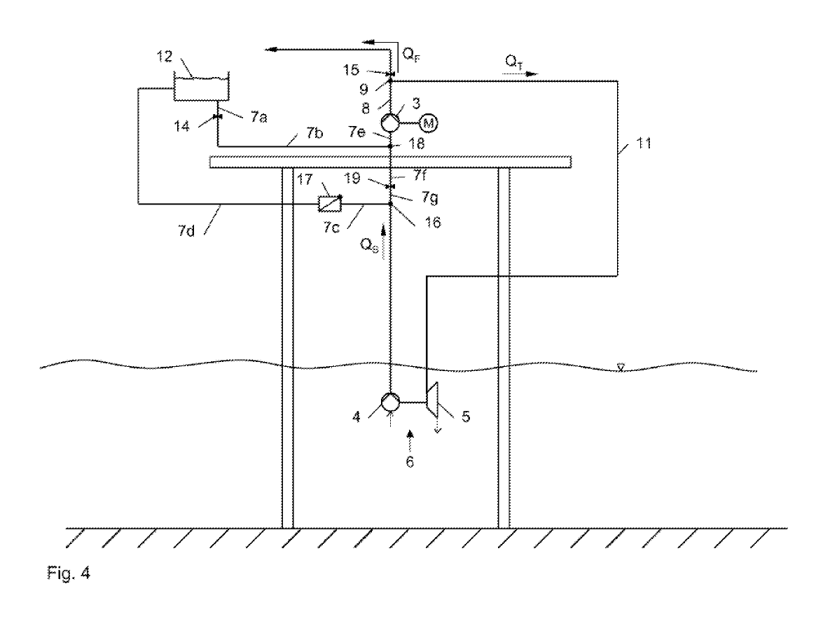

If, as shown in FIG. 4, the valve 17 is designed as a check valve, for example as a swing check valve, the vent line 7h, shown in FIG. 3, which is fluidically connected to an outlet opening of the distribution device 16, and the vent valve 20, can be dispensed with. The valve 17, which is designed as a check valve, prevents an escape of water, which is contingent upon level differences of the tank 12 and the pump unit 4 of the pump-turbine assembly 6, and, moreover, allows the air which is present in the system to escape via the open tank 12.

For starting the system, that is to say when the pump 3 is started, the valves 15 and 19 are closed. The valve 14 is opened and via the lines 7a, 7b and 7e the water flows out of the tank 12 into the pump 3, which is connected to the distribution device 18, and from the pump 3 flows into the sea via the lines 8 and 11 and also the turbine unit 5. The pump unit 4 of the pump-turbine assembly 6 delivers the water extracted from the sea via the lines 7, 7c and 7d into the tank 12. If the tank 12 has again reached its defined filling level for restarting the system, the valve 14 is closed in order to keep the water in the tank 12, and the valves 15 and 19 are opened in order to feed the pump 3, via the pump unit 4 and the lines 7, 7g, 7f and 7e, with the water extracted from the sea by the pump unit 4 and to supply one or more water extraction points with the delivered amount of water.

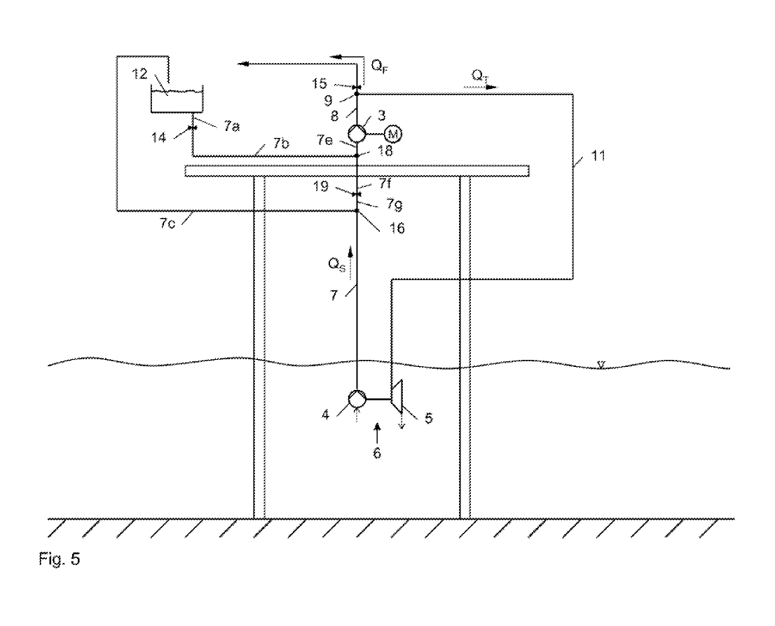

If, as shown in FIG. 5, the feed into the tank 12, which is fully or partially open on the upper side, is carried out in a region above the water level, it is ensured that the air which is present in the system can escape and despite the given level differences no water can escape from the tank 12 through the pump unit 4 of the pump-turbine assembly 6, which is contingent upon level differences. The construction is simplified to the effect that the components, shown in FIG. 3, comprising valve 17, vent line 7h and vent valve 20 can also be dispensed with here. The line 7c is connected by one end to an outlet opening of the distribution device 16 and terminates at the other end in a region above the water level of the tank 12. The connection of the lines 7a, 7b, 7e, 7f and 7g and also of the valve 19 is carried out in a way similar to the exemplary embodiment shown in FIG. 3.

During the starting of the pump 3, the valves 15 and 19 are closed and the valve 14 is opened. Via the lines 7a, 7b and 7e, the water flows out of the tank 12 into the pump 3, which is connected to the distribution device 18, and from there flows into the sea via the lines 8 and 11 and also the turbine unit 5. The pump unit 4 of the pump-turbine assembly 6 delivers water via the lines 7 and 7c into the tank 12 until this has reached the defined filling state for restarting the system. After this, the valve 14 is closed so that water can no longer be delivered from the tank. The valves 15 and 19 are opened in order to feed the pump 3, via the pump unit 4 and the lines 7, 7g, 7f and 7e, with the water extracted by the pump unit 4 from the sea so that the necessary first partial volume flow Q_{F} is available at the water extraction points.

FIGS. 3 to 5 are shown with a tank 12 which is open on its upper side but which alternatively can be designed as a closed tank, according to FIG. 1.

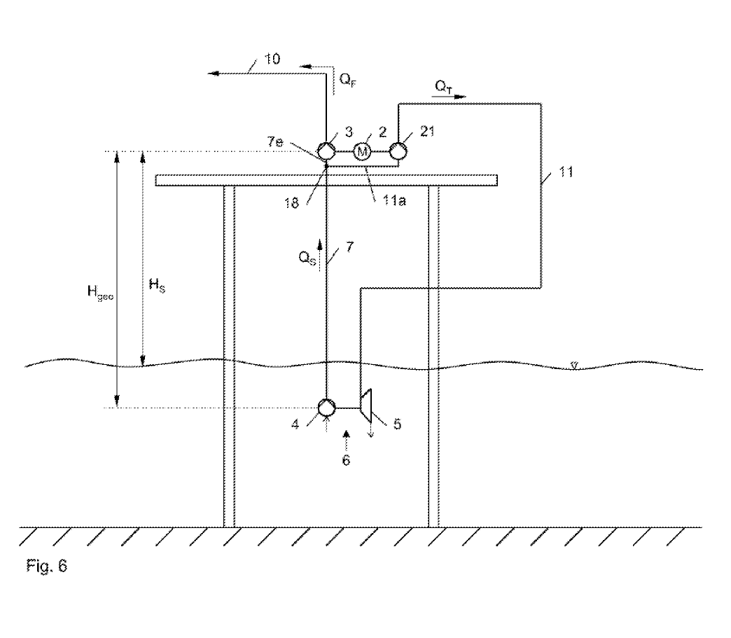

FIG. 6 shows a further exemplary embodiment according to the invention. The discharge port of the pump unit 4 is connected to a suction port of a pump device 21, preferably a high-pressure pump. The discharge port of the pump unit 4 of the pump-turbine assembly 6 is connected in this case to the inlet opening of the distribution device 18 via the line 7 conducting the volume flow Q_{S}. The first outlet opening of the distribution device 18 leads via the line 7e to the suction port of the pump 3. The discharge port of the 3 is connected to the at least one water extraction point via the line 10 conducting the first partial volume flow Q_{F}. The second outlet opening of the distribution device 18 is connected to a suction port of the pump device 21 via a thirteenth line 11a. A discharge port of the pump device 21 is connected to the inlet port of the turbine unit 5 of the pump-turbine assembly 6 via the line 11 conducting the second partial volume flow Q_{T}. Whereas in FIGS. 1 to 5 the discharge port of the pump 3 is connected via the distribution device 9, that is to say indirectly, to the inlet port of the turbine unit 5, in this exemplary embodiment the discharge port of the pump device is connected directly to the turbine unit. The feed water for the pump device 21 is therefore extracted as a partial volume flow of the pump unit 4 of the pump-turbine assembly 6. The pump device 21 has as a rule a lower delivery rate than the pump 3 and delivers the second partial volume flow Q_{T} for driving the turbine unit 5. The pump device 21 is preferably driven by means of the existing motor 2. Alternatively, another drive device can also be provided for the pump device 21.

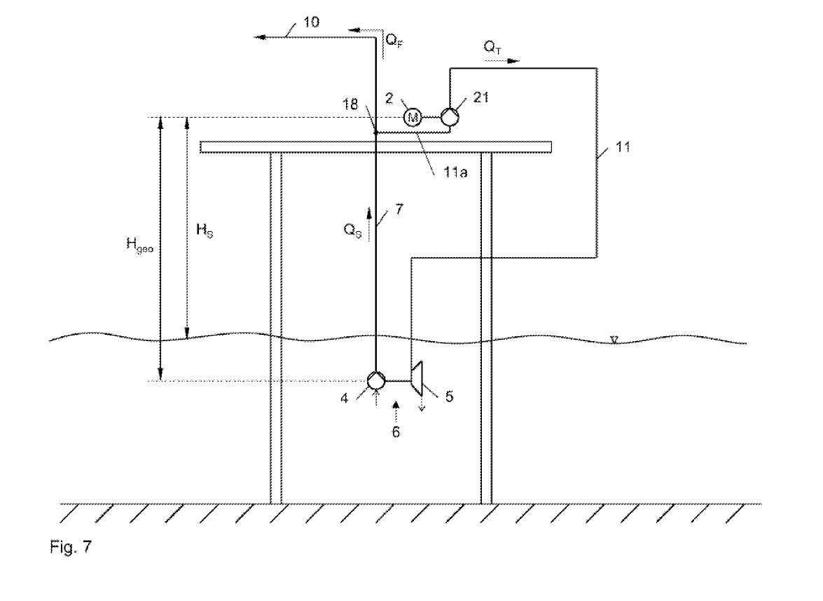

In the case of the embodiment of the invention shown in FIG. 7, only the pump device 21 which is incorporated in the line 11 and driven by the motor 2 is provided on the platform. The discharge port of the pump unit 4 is connected to the inlet opening of the distribution device 18 via the line 7 conducting the volume flow Q_{S}. The first outlet opening of the distribution device 18 is connected to the at least one water extraction point—not shown—via the line 10 conducting the first partial volume flow Q_{F}. The second outlet opening of the distribution device 18 is connected to the suction port of the pump device 21 via the line 11a conducting the second partial volume flow Q_{T}. The pump device 21 on the platform therefore obtains its feed water from the pump unit 4 of the pump-turbine assembly 6. Via the line 11 conducting the second partial volume flow Q_{T}, the discharge port of the pump device 21 is fluidically connected to the suction port of the turbine unit 5 of the pump-turbine assembly 6 which is located beneath the sea level. The pump unit 4 of the pump-turbine assembly 6 in this case takes over the task of the pump 3 shown in FIGS. 1 to 6 and so provides the required first partial volume flow Q_{F} for the at least one water extraction point, for example for firefighting, the required pressure head H_{D} plus the suction head H_{S}, and also the second partial volume flow Q_{T} for feeding the pump-turbine assembly 6.

The embodiment of the water lifting system according to FIGS. 6 and 7 with a water supply corresponds in the main to the possibilities which are described in FIGS. 1 to 5 and represented in the corresponding figures. The tank 12 is placed on the offshore installation 1, wherein an outlet opening of the tank 12 is connected to the suction port of the pump 3 and/or to the suction port of the pump device 21, and an inlet opening of the tank 12 is connected to the discharge port of the pump unit 4 of the pump-turbine assembly 6.

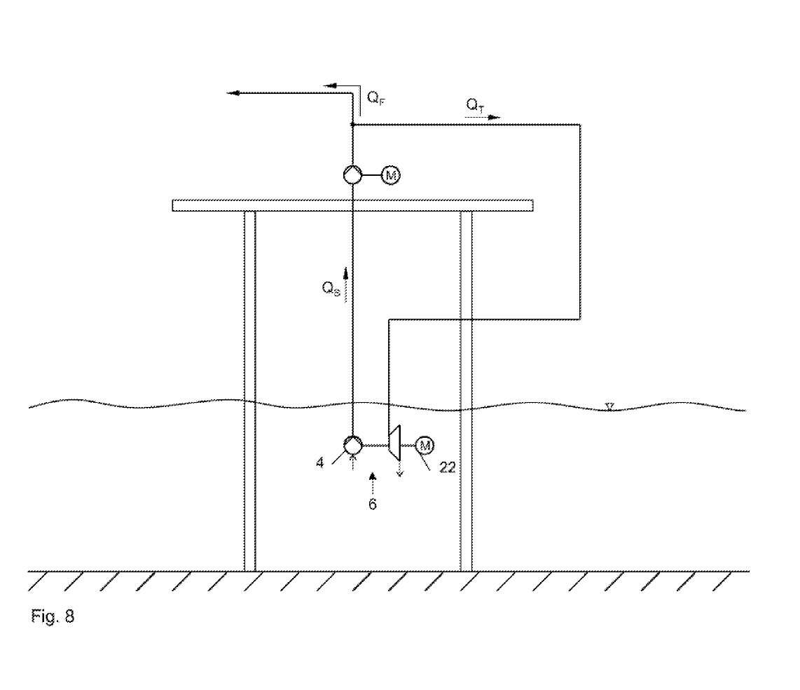

Since the pump-turbine assembly 6 resides permanently in seawater with high salt content, it has to be protected against seizure of the rotor. To this end, by way of example, as shown in FIG. 8, an electric motor 22 can be attached to the pump-turbine assembly 6 and allows this to rotate at regular intervals. In this case, a slow rotational movement is sufficient without the pump unit 4 delivering water. An electric motor with a high pole count can advantageously be used. As a result, the use of a transmission is avoided. The electric motor, moreover, has to be designed for the rotational speeds during operation of the pump-turbine assembly 6.

Alternatively to this, the entire system could also be started at regular intervals. In this way, the function could be checked and seizing up of the assembly prevented.

FIGS. 1 to 8 schematically show an offshore installation with reference to which the construction and principle of operation of the water lifting system according to the invention was discussed. Alternatively, the water lifting system according to the invention can also find use on a ship or the like.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF DESIGNATIONS

1 Offshore installation
2 Motor
3 Pump
4 Pump unit
5 Turbine unit
6 Pump-turbine assembly
7 Line
7a Line
7b Line
7c Line
7d Line
7e Line
7f Line
7g Line
7h Vent line
8 Line
9 Distribution device
10 Line
10a Line
11 Line
11a Line
12 Tank
13 Vent valve
14 Valve
15 Valve
16 Distribution device
17 Valve
18 Distribution device
19 Valve
20 Vent valve
21 Pump device
22 Electric motor
Q_{S} Volume flow
Q_{F} First partial volume flow
Q_{T} Second partial volume flow
H_{S} Suction head
H_{geo} Geodetic head

1-12. (canceled)

13. A water lifting system, comprising:
a pump having an inlet port and a discharge port;
a pump-turbine assembly having a pump unit and a turbine unit, the pump unit and turbine unit in each case having an inlet port and a discharge port;
a volume flow line arranged to conduct a volume flow between the pump unit discharge port and the pump inlet port, the volume flow including a first partial volume flow and a second partial volume flow;
a first partial volume flow line conducting the first partial volume flow to at least one water extraction point; and
a second partial volume flow line conducting the second partial volume flow connected to the turbine unit inlet port.

14. The water lifting system as claimed in claim 13, wherein
the discharge port of the turbine unit is arranged to directly or indirectly discharge to a water reservoir.

15. The water lifting system as claimed in claim 13, further comprising:
a water supply tank having an tank outlet opening connected to the pump inlet port.

16. The water lifting system as claimed in claim 15, wherein
the volume flow line is connected to an inlet opening of the tank.

17. The water lifting system as claimed in claim 15, wherein the volume flow line is connected to the tank outlet opening.

18. The water lifting system as claimed in claim 13, wherein
the pump discharge port is connected to the at least one water extraction point by the first partial volume flow line.

19. The water lifting system as claimed in claim 13, wherein
the pump discharge port is connected to the turbine unit inlet port by the second partial volume flow line.

20. The water lifting system as claimed in claim 18, wherein
the pump discharge port is connected to the turbine unit inlet port by the second partial volume flow line.

21. The water lifting system as claimed in claim 13, wherein
the pump unit discharge port is connected to an inlet port of an additional pump device.

22. The water lifting system as claimed in claims 21, wherein
a discharge port of the additional pump is connected to the turbine unit inlet port by the second partial volumetric flow line.

23. The water lifting system as claimed in claim 13, wherein
an electric motor is arranged to drive the pump-turbine assembly.

24. A method for operating a water lifting system, the water lifting system including a pump having an inlet port and a discharge port, a pump-turbine assembly having a pump unit and a turbine unit, the pump unit and turbine unit in each case having an inlet port and a discharge port, a volume flow line arranged to conduct a volume flow between the pump unit discharge port and the pump inlet port, the volume flow including a first partial volume flow and a second partial volume flow, a first partial volume flow line conducting the first partial volume flow to at least one water extraction point, a second partial volume flow line conducting the second partial volume flow connected to the turbine unit inlet port, and a water reservoir, comprising the acts of:
extracting the first partial volume flow from the water reservoir;
delivering the first partial volume flow extracted from the water reservoir via the volume flow line to the at least one water extraction point via the first partial volume flow line;
delivering the second partial volume flow extracted from the water reservoir via the volume flow line back to the water reservoir via the second partial volume flow line.

25. The method of claim 24, wherein
the act of delivering the second partial volume flow back to the water reservoir includes passing the second partial volume flow through the turbine unit.
